(19) United States
(12) Patent Application Publication
(10) Pub. No.: US 2025/0085606 A1
(43) Pub. Date: Mar. 13, 2025

(54) DEVICE AND METHOD FOR HIGH-SPEED TUNING SOLITON MICROCOMB

(71) Applicant: University of Rochester, Rochester, NY (US)

(72) Inventors: Qiang Lin, Rochester, NY (US); Yang He, Rochester, NY (US)

(21) Appl. No.: 18/286,898

(22) PCT Filed: May 15, 2023
(86) PCT No.: PCT/US2023/067004

§ 371 Date: Oct. 13, 2023

Related U.S. Application Data
(60) Provisional application No. 63/341,632, filed on May 13, 2022.

(51) Int. Cl. G02F 1/35; G02F 1/015

(52) U.S. Cl. CPC G02F 1/3513; G02F 1/0154; G02F 1/3517; G02F 2201/12; G02F 2203/56

(57) ABSTRACT

A device and method for high-speed tuning soliton microcomb comprising an on-chip high-Q lithium niobate (LN) microresonator as a comb resonator whose dispersion is engineered for soliton comb generation where a strong electro-optic Pockels effect is used to dynamically tune the soliton repetition rate, with integrating electrooptic tuning and modulation elements directly integrated into the comb resonator.

### CROSS-REFERENCE TO RELATED APPLICATIONS

This application claims priority to and the benefit of U.S. provisional patent application Ser. No. 63/341,632, entitled DEVICE AND METHOD FOR HIGH-SPEED TUNING SOLITON MICROCOMB, filed May 13, 2023, the contents of which are incorporated herein by reference in its entirety.

### STATEMENT REGARDING FEDERALLY FUNDED RESEARCH OR DEVELOPMENT

This invention was made with government support under HDTRA11810047 awarded by Department of Defense, HR001-20-2-0044 awarded by Defense Advanced Research Projects Agency, ECCS-1810169, ECCS-1842691 and, OMA-2138174 awarded by the National Science Foundation. The government has certain rights in the invention.

### TECHNICAL FIELD

The application relates to comb generation, and, more particularly, relates to soliton comb generation.

### BACKGROUND

Spectrally pure microwaves are essential for many applications ranging from wireless communication, radar, imaging, clock, to high-speed electronics. Highly coherent microwaves can be produced with various photonic technologies such as optoelectronic oscillator, dual-frequency laser, Brillouin laser, etc., among which phase-locked Kerr frequency comb produced on a monolithic chip soliton microcomb is of great promise given its exceptional coherent properties. The superior coherence of soliton microcombs has led to a variety of applications such as optical communication, spectroscopic sensing, range measurement, optical frequency synthesis, neuromorphic computing, etc. Recently, significant interest has been focused on developing soliton microcombs with a repetition rate in the radio and microwave frequency ranges with the potential of microwave synthesis on an integrated chip.

High-speed frequency tuning and modulation of microwaves is crucial for a variety of important applications such ranging, communication, imaging, gesture recognition, among many others. The repetition rates of current soliton microcombs are fundamentally determined by the physical sizes of the monolithic comb resonators, which cannot be changed after the devices are made. Consequently, tuning of microwave frequency has to rely on external approaches such as external laser modulation that are relatively slow or external comb modulation whose efficiency is fairly limited.

### SUMMARY

Coherent microwave with a fast tunable frequency underlies crucially many important applications ranging from sensing, imaging, ranging, timekeeping, wireless communication, to high-speed electronics. With a superior coherence property, soliton microcombs exhibit great promise for microwaves synthesis on a chip. Its repetition rate, however, exhibits fairly limited tunability due to the monolithic nature of the underling comb resonator.

In embodiments, the first microwave-rate soliton microcomb whose repetition rate can tune data high speed is provided. By integrating an electro-optic tuning/modulation element directly into the lithium niobate comb microresonator, a frequency modulation speed up to 75 MHz that is orders of magnitude faster than other soliton comb devices reported to date, and a frequency modulation rate up to 1.0×1015 Hz/s that is even faster than the state-of-the-art electronic microwave frequency modulation technology is achieved. The device offers a significant bandwidth up to tens of gigahertz for locking of the repetition rate to an external microwave reference enabling both direct injection locking and feedback locking to the comb resonator itself without involving external modulation. The demonstrated fully integrated electro-optically reconfigurable soliton microcomb now opens up a great avenue towards high-speed dynamic control and processing of microwaves, which is expected to have a profound impact on broad applications in microwave photonics.

In illustrative embodiments, a device and method for high-speed tuning soliton microcomb comprises an on-chip high-Q lithium niobate (LN) microresonator as a comb resonator whose dispersion is engineered for soliton comb generation where a strong electro-optic Pockels effect is used to dynamically tune the soliton repetition rate, with integrating electrooptic tuning and modulation elements directly integrated into the comb resonator.

The repetition rate of the microwave-rate soliton microcomb can be tuned at a high speed.

By taking advantage of the strong electro-optic Pockels effect of LN and by integrating electro-optic tuning and modulation component directly into the LN comb resonator, a frequency modulation speed up to 75 MHz that is orders of magnitude faster than other soliton comb devices reported to date, and a frequency modulation rate up to 1.0×1015 Hz/s that is even faster than the state-of-the-art electronic microwave FM technology is achieved.

The device can exhibit a modulation efficiency of ˜2 MHz/V, which can be further increased by six times with all the three groups of driving electrodes employed.

The demonstrated device can offer a significant bandwidth (up to tens of gigahertz) for feedback locking of the repetition rate to an external reference source, enabling both direct injection locking and feedback locking to the comb resonator itself without involving external modulation.

The low-frequency phase noise can be suppressed directly down to that of the reference source.

The demonstrated device and approach unite elegantly the superior coherence of soliton microcombs with high-speed dynamic modulation, and opens up a great avenue towards electro-optic processing of coherent microwaves that is expected to find broad applications in microwave synthesis, time keeping, ranging, 5G/6G communications, among many others.

The direct EO tuning and modulation of the soliton comb lines can be expected to have a profound impact on the general photonic applications of soliton microcombs including frequency metrology, optical frequency synthesis, LiDAR, and optical communication.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a view of a high speed tunable microware-rate soliton device according to one or more illustrative embodiments of the present invention.

FIG. 2 is a view of an LN chip of the device of FIG. 1 according to one or more illustrative embodiments of the present invention.

FIGS. 3A-3C are views of the driving electrode and resonator waveguide of the device of FIGS. 1 and 2 according to one or more illustrative embodiments of the present invention.

FIG. 4 is a view illustrating optical spectra of soliton combs with a repetition rate of 200 GHz of the device according to one or more illustrative embodiments of the present invention.

FIGS. 5A and 5B are views illustrating optical spectra of soliton combs with a repetition rate of 200 GHz of the device according to one or more illustrative embodiments of the present invention.

FIGS. 6A-6C are views illustrating optical spectra of soliton combs with a repetition rate of 19.8 GHz of the device according to one or more illustrative embodiments of the present invention.

FIGS. 7A-7C are views illustrating optical spectra of soliton combs with a repetition rate of 13.5 GHz of the device according to one or more illustrative embodiments of the present invention.

FIG. 8A is a view illustrating electro-optic tuning performance of the comb resonator of the device according to one or more illustrative embodiments of the present invention.

FIG. 8B is a view illustrating electro-optic tuning modulation response of the comb resonator of the device according to one or more illustrative embodiments of the present invention.

FIGS. 9A-9C are views illustrating frequency modulation of the soliton comb repetition rate at a modulation frequency of 1 MHz according to one or more illustrative embodiments of the present invention.

FIGS. 10A-10C illustrate frequency modulation of the soliton comb repetition rate at a modulation frequency of 10 MHz according to one or more illustrative embodiments of the present invention.

FIGS. 11A-11C illustrate frequency modulation of the soliton comb repetition rate at a modulation frequency of 50 MHz according to one or more illustrative embodiments of the present invention.

FIGS. 12A-12C illustrate frequency modulation of the soliton comb repetition rate at a modulation frequency of 75 MHz according to one or more illustrative embodiments of the present invention.

FIG. 13 illustrates an experimental testing schematic for locking of the soliton repetition rate of the device to a reference microwave source. according to one or more illustrative embodiments of the present invention.

FIG. 14A is a view illustrating the electro-modulation response of the comb resonator of the device evaluated with the schematic of FIG. 13 according to one or more illustrative embodiments of the present invention.

FIG. 14B is a view illustrating the detected phase noise spectrum of the comb resonator of the device evaluated with the schematic of FIG. 13 according to one or more illustrative embodiments of the present invention.

### DETAILED DESCRIPTION

In illustrative embodiments, the present invention is directed to a microwave-rate soliton microcomb whose repetition rate can be tuned with a speed up to, for example, 75 MHz, which is orders of magnitude faster than conventional soliton microcomb sources. The device exhibits a significant frequency modulation (FM) rate in the order of ˜1×10¹⁵ Hz/s that is even larger than state-of-the-art electronic microwave FM technology with significantly higher phase noise performance. Moreover, the device offers increased bandwidth for direct locking of microwave frequency to an external reference source, free from the bandwidth constraint of current locking approaches that rely on external laser modulation. The high-speed dynamic control and processing capability of microwaves offered by illustrative embodiments of the microcomb provide increased potential for broad applications in microwave photonics.

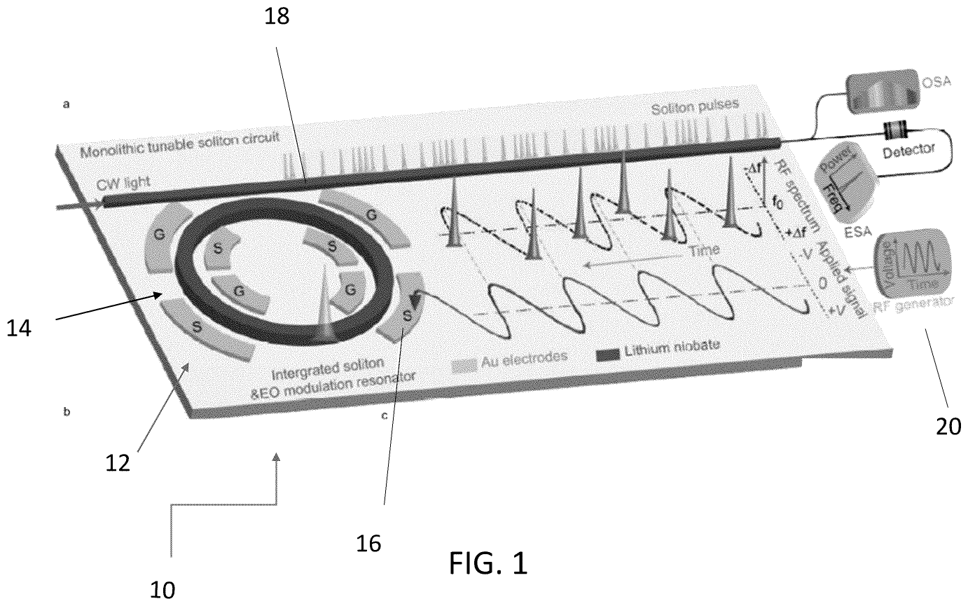

Referring now to FIG. 1, one illustrative embodiment of the system and device of the present invention is illustrated. The underlying device 10 is an on-chip high-Q lithium niobate (LN) microresonator 12 whose dispersion is structured for soliton comb generation. The device platform enables self-starting and bi-directional switching of the soliton states with the assistance of the photorefractive effect. LN also exhibits a strong electro-optic Pockels effect. Thus, in illustrative embodiments, the present invention utilizes this effect for dynamically tuning the soliton repetition rate, by directly integrating electro-optic tuning and modulation elements into the comb resonator. The LN resonator functions simultaneously as a soliton comb generator and a high-speed electro-optic (EO) modulator. The fully integrated device not only enables high-speed tuning of the soliton repetition rate, but also offers enormous bandwidth for locking of the repetition rate to an external microwave reference, via a direct feedback to the comb resonator itself.

In one illustrative embodiment, the device a dispersion-engineered high-quality micro-ring resonator 12 on the lithium niobate platform 14 for soliton comb generation. Driving electrodes 16 are integrated directly with the comb generation resonator and used to high-speed modulate the resonator via the electro-optic Pockels effect. A coupling waveguide 18 couples the pump laser into the comb resonator and the produced soliton comb output from the comb resonator. An RF/microwave from an external microwave source 20 is applied to the driving electrodes to electro-optically modulate the comb resonator. This can function in two ways: a) it can produce high-speed modulation on the repetition rate of the soliton comb and thus produce frequency modulation on the produced microwave; and/or it can be used to injection locking or feedback locking of the soliton repetition rate to the external reference microwave source. Moreover, the detected microwave (from the optical detector) can be applied to the driving electrode, which forms self-injection locking of the soliton comb, leading to a self-sustaining coherent microwave oscillator.

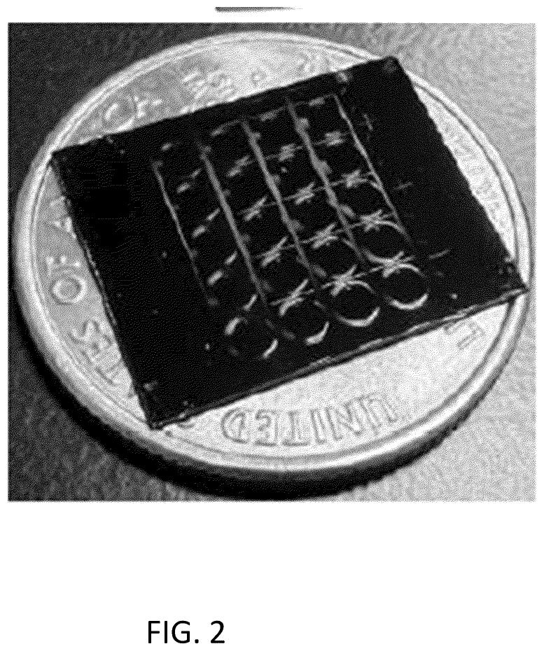

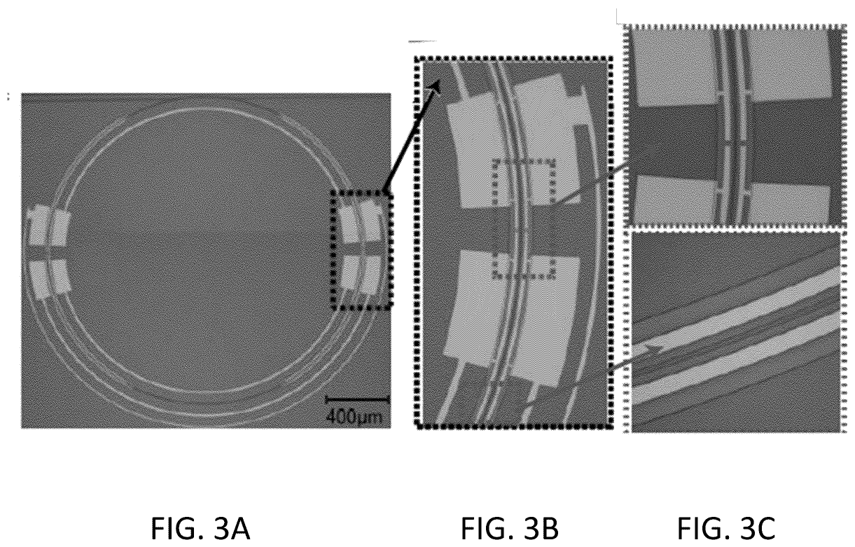

FIG. 2 illustrates an example of the LN chip, which was fabricated on a z-cut LN-on-insulator (LNOI) wafer platform. FIGS. 3A-3C show the detailed structure of a device which consists of a micro ring resonator, a pulley bus waveguide, and driving electrodes (FIG. 1). In embodiments, the ring resonator is designed to have a waveguide width of, for example, 2.2 micron, which yields a group velocity dispersion of about −0.035 ps2/m in the telecom band for the fundamental quasi-transverse-electric (quasi-TE) mode family that is suitable for soliton generation. The electrodes are placed along the ring resonator waveguide with an electrode-waveguide spacing of about 4 microns so as to optimize the electro-optic tuning/modulation efficiency while without impacting the optical Q of the resonator. The electrodes are designed to be 525 nm in thickness and 5 micron wide in order to support high-speed modulation. The LN micro ring resonator exhibits an intrinsic optical Q of about 4 million. The same level of optical Q is maintained for resonators with different sizes, with a radius up to 1.5 mm.

The repetition rate fr of a soliton microcomb is primarily determined by the resonator size. By changing the radius of the ring resonator from 100 μm to 450 μm, the fr is reduced from 200 GHz to 44.84 GHz, as shown in FIGS. 1 and 2. However, further increase of resonator size is not trivial due to the interference of stimulated Raman scattering. LN exhibits rich Raman scattering characteristics which were recently shown to introduce intriguing self-frequency shift (SFS) on the Kerr solitons. However, it could also excite Raman lasing when a Stokes frequency matches a cavity resonance. For a resonator with a radius ≥1 mm, the free-spectral range is small enough (<20 GHz) that Raman lasing becomes unavoidable, which perturbs the soliton generation. For the z-cut resonators employed herein, the major disturbance comes from the Stokes wave with a Raman frequency shift of 19 THz that is associated with the A₁(TO₄) phonon mode of LN. To resolve this issue, the pulley bus waveguide is designed such that it is close to critical coupling at the pump wavelength around 1550 nm while it is over coupled at the Raman Stokes wavelength around 1720 nm. As a result, the Raman lasing can be suppressed and to easily produce soliton combs.

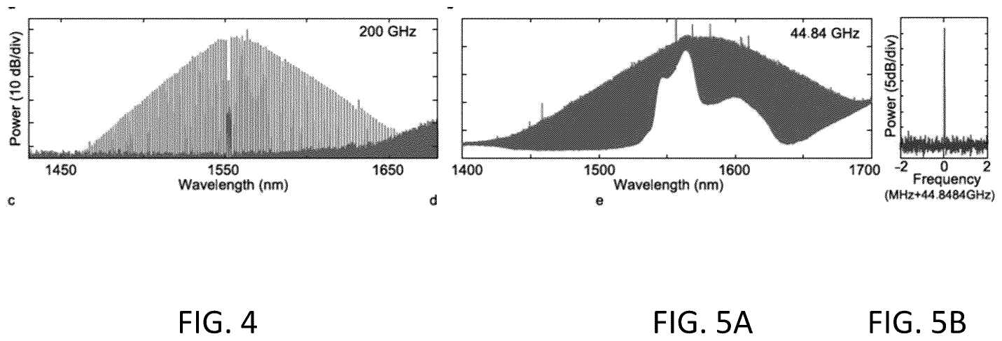

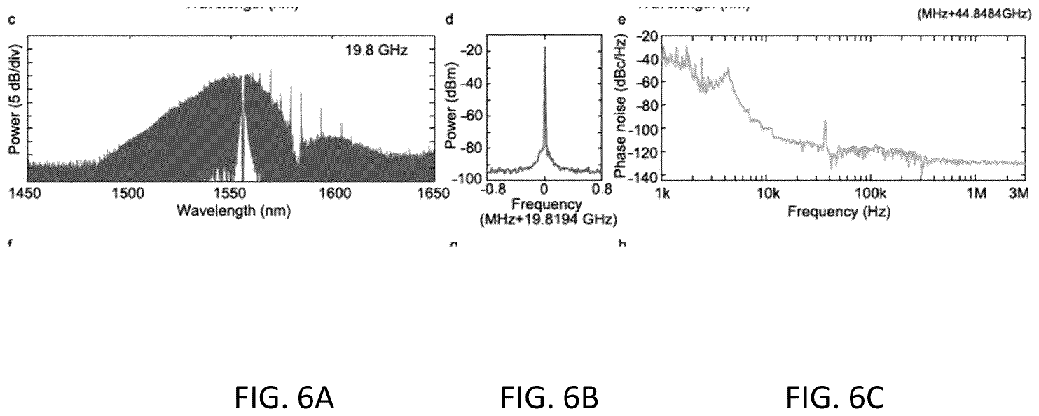

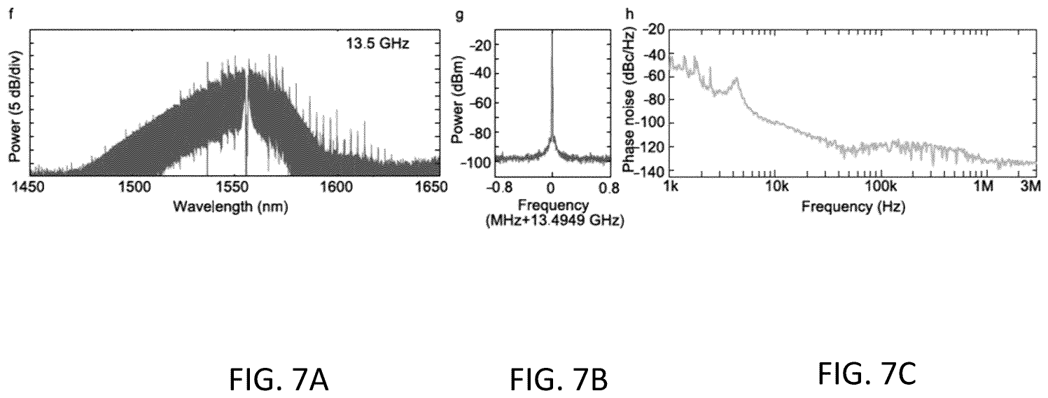

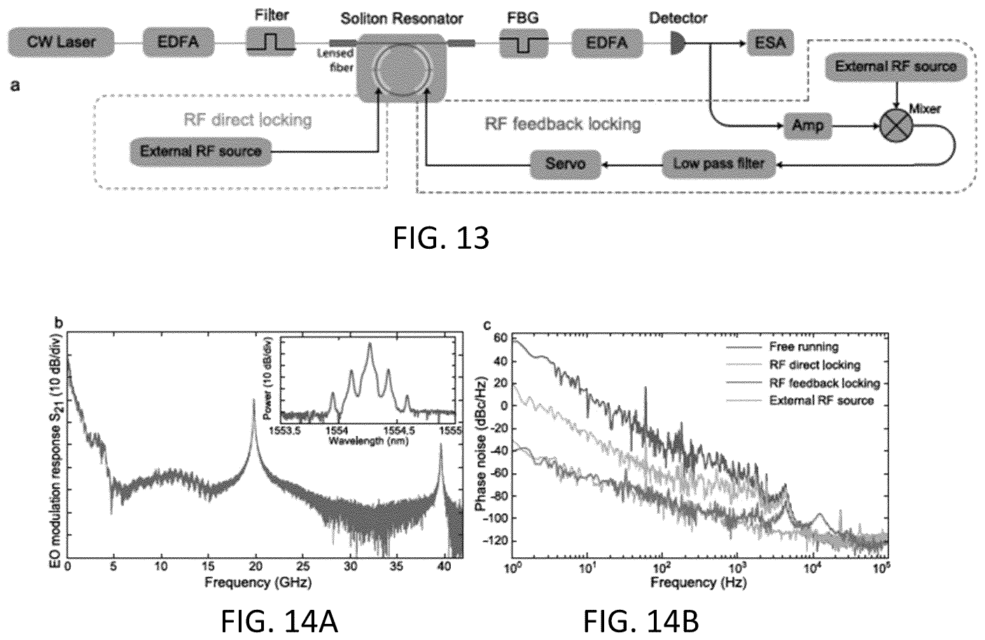

FIGS. 4-7 illustrate exemplary microcombs with different repetition rates. More specifically, optical spectra of soliton combs with a repetition rate of 200 GHz (FIG. 5), 44.84 GHz (FIGS. 5A and 5B), 19.8 GHz (FIGS. 6A-6C) and 13.5 GHz (FIGS. 7A-7C), which are generated in LN comb resonators with a radius of 100 μm (FIG. 4), 450 μm (FIGS. 5A and 5B), 1020 μm (FIGS. 6A-6C) and 1500 μm (FIGS. 7A-7C) with on-chip power of 33 mW, 396 mW, 282 mW and 400 mW, respectively. FIG. 5B shows the spectrum of the detected microwave from the 44.84 GHz soliton comb. FIGS. 6B and 6C depict the spectrum and phase noise of the detected 19.82 GHz microwave produced from the soliton comb shown in FIG. 6A. FIGS. 7A and 7B depict the spectrum and phase noise of the detected 13.5 GHz microwave produced from the soliton comb shown in FIG. 7A. In FIGS. 6B and 7B, the resolution bandwidth (RBW) of the RF spectrum is 200 Hz. In all the embodiments, the devices are running without active feedback, and the pump-laser detuning is stabilized by the photorefractive effect.

For example, FIGS. 6A and 7A illustrate two examples of soliton microcombs with a fr of 19.82 GHz and 13.5 GHz, respectively. The slight spectral distortion around 1580 nm is due to a side effect of the designed bus waveguide which is under coupled at this wavelength. This side effect, however, does not impact the integrity of the produced Kerr solitons and the coherence of the soliton combs is clearly represented by the detected microwaves shown in FIGS. 6B and 7B where both microwaves at 19.82 and 13.5 GHz exhibit a signal-to-noise ratio greater than 70 dB. As shown in FIGS. 6C and 7C, the phase noise of the microwaves is about −40 dBc/Hz at 1 kHz, reaches −110 dBc/Hz at 10 kHz, and finally goes below −130 dBc/Hz at 3 MHz. This level of phase noise is comparable to those demonstrated recently on other on-chip platforms. The spectral bump around 4 kHz is likely due to the impact of the frequency noise of the pump laser.

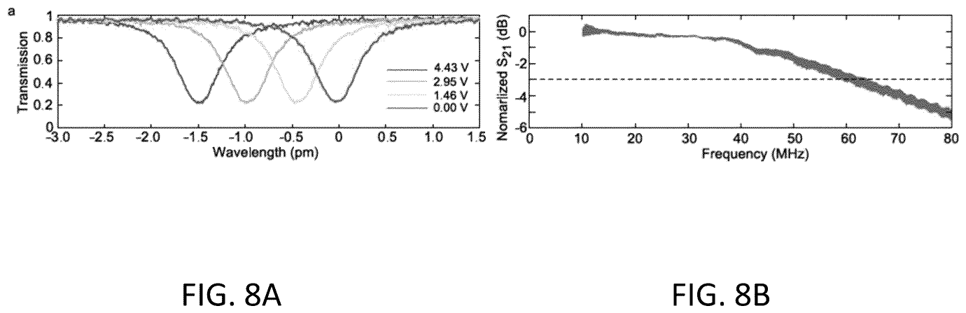

In order to dynamically tune and modulate the microwave-rate solitons, the EQ tuning/modulating components are integrated directly onto the comb resonator as shown in FIG. 1. For the z-cut resonator, an r22 electro-optic tensor element of LN to tune the fundamental quasi-TE modes. In particular, for a circularly shaped ring resonator, a detailed analysis shows that the EQ tuning efficiency can be maximized with three groups of driving electrodes each of which contains two pairs of signal-ground electrodes and spans over an angle of 60 degrees. A detailed device layout is shown in FIGS. 3A-3C, in which only two groups of electrodes are fabricated so as to avoid the interference with the coupling bus waveguide (see also FIG. 1) For simplicity of experimental testing, only one group of electrodes for EQ tuning and modulation is utilized, yet the integrated EQ tuning can still achieve a reasonably good tuning efficiency of 0.34 μm/V for the cavity resonances, an example is shown in FIGS. 8A and 8B. FIG. 8A illustrates DC tuning of a cavity resonance. FIG. 8B illustrates electro-optic modulation response S₂₁ of the comb resonator. The same figure also shows the EQ modulation response of the comb device, which indicates a 3 dB bandwidth of about 61 MHz that corresponds to the photon lifetime limit of the comb resonator.

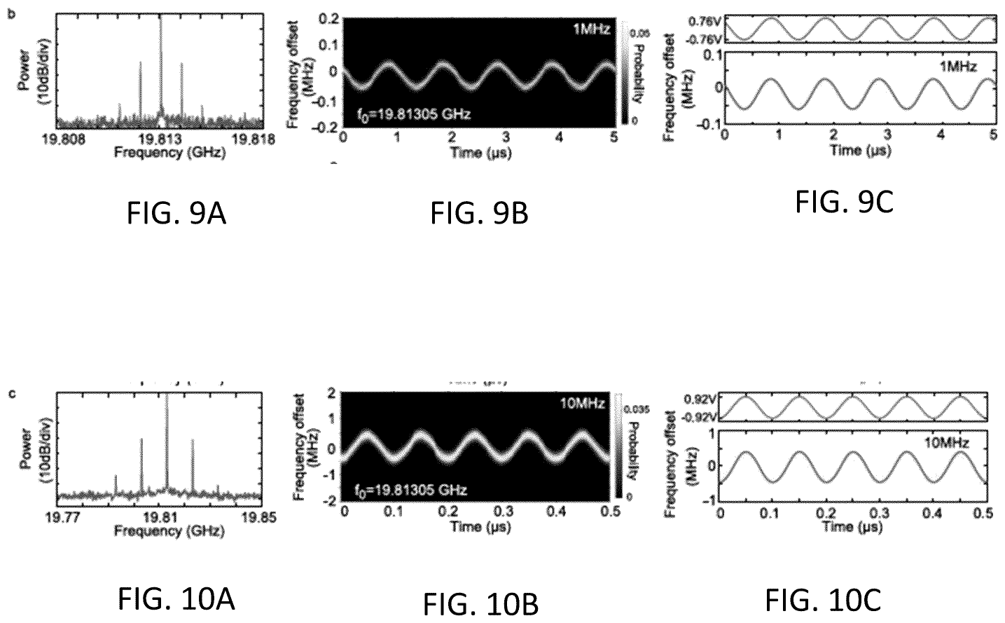

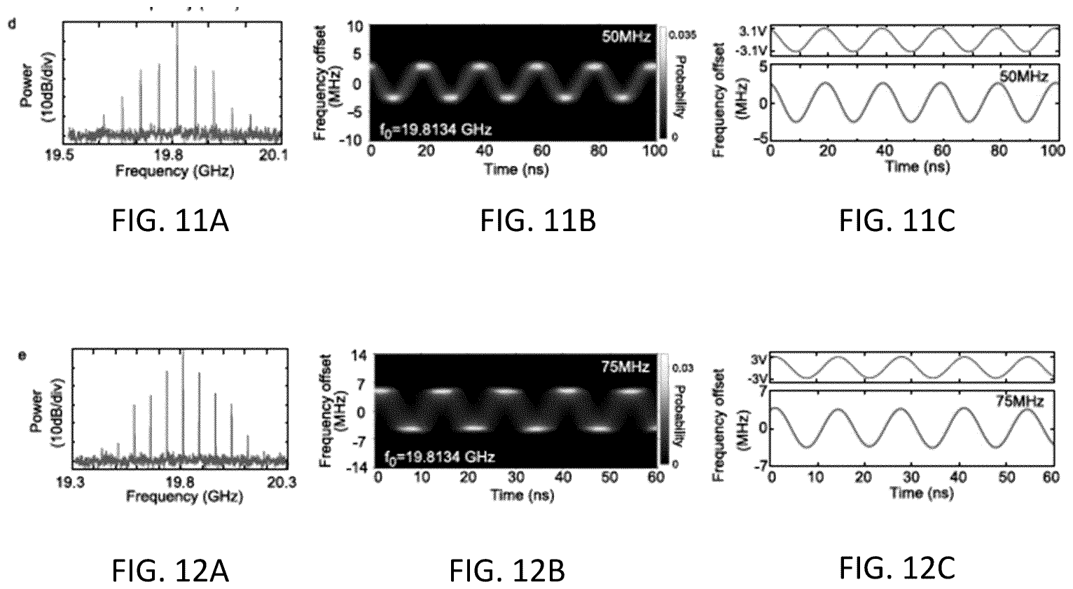

The broadband EO response of the present device enables high-speed control of the soliton microcomb. To depict this feature, a sinusoidal electric signal is applied to the 19.81 GHz comb resonator and the frequency of the detective wave is monitored. FIGS. 9A-9C illustrate frequency modulation of the soliton comb repetition rate at a modulation frequency of 1 MHz. FIGS. 10A-10C illustrate frequency modulation of the soliton comb repetition rate at a modulation frequency of 10 MHz. FIGS. 11A-11C illustrate frequency modulation of the soliton comb repetition rate at a modulation frequency of 50 MHz. FIGS. 12A-12C illustrate frequency modulation of the soliton comb repetition rate at a modulation frequency of 75 MHz. In FIGS. 9A, 10A, 11A and 12A, the spectrum of the detected microwave is depicted. In FIGS. 9B, 10B, 11B and 12B, the frequency vs. time spectrum is depicted. In FIGS. 9C, 10C, 11C and 12C the time-dependent frequency curve, which is the average trace of the frequency vs. time spectrum is depicted. In all embodiments, the device is free running without active feedback, and the pump laser-cavity detuning is self-stabilized by the photorefractive effect. More specifically, as shown, the sinusoidal EO driving produces a direct sinusoidal frequency modulation (FM) of the microwaves. At a modulation frequency of 1 MHz (FIG. 9A-9C), a peak driving voltage VP=0.76V produces an FM amplitude of 41.8 kHz which corresponds to an FM efficiency of 55 kHz/V. The FM efficiency increases considerably with the modulation frequency, reaching a value of 463 kHz/V and 824 kHZ/V at the modulation frequency of 10 MHz (FIGS. 10A-10C) and 50 MHz (FIG. 11A-11C. As shown in FIGS. 12A-12C, the microwave is modulated at a frequency as high as 75 MHz, where a driving voltage VP=3.0V produces an FM amplitude of 3.45 MHz, corresponding to an FM efficiency of 1.15 MHz/V. The blurring of the time-frequency spectrum is simply due to the limited bandwidth (160 MHz) of the spectrum analyzer (Tektronics RSA5126B) for the time-dependent frequency characterization. For the same reason, the time-dependent frequency analysis likely underestimates the FM amplitude since it only captures the firs-order modulation sidebands as such a high modulation frequency. The microwave spectrum shown in FIGS. 10A-10C infers an FM amplitude of about 6.0 MHz, implying an FM efficiency of about 2.0 MHZ/V., respectively

The FM efficiency drops, however, with further increased modulation frequency, simply due to the photon lifetime limit of the resonator. On the other hand, the frequency modulation rate increases with increased modulation frequency, reach a value of ˜1.0×1015 Hz/s at the modulation frequency of 75 MHz. This FM rate is orders of magnitude faster than other soliton comb devices. It is even faster than electronic microwave FM technology developed to date, while the soliton comb here offers a phase noise more than 20 dB lower than the electronic counterparts.

One mechanism responsible for the observed FM of the microwave is the Raman-induced SFS of the solitons whose magnitude depends on the laser-cavity detuning. EO modulation of the comb resonator modulates the laser-cavity detuning of the pump wave which in turn changes the magnitude of SFS and thus shifts the carrier frequency of the Kerr solitons. Due to the group-velocity dispersion of the resonator, such a shift of soliton carrier frequency would translate into a change of free-spectral range, leading to a modulation of the repetition rate. As shown in the SI, this mechanism accounts for an FM efficiency of ˜(100-200) kHz/V, which explains well the observed phenomena at low modulation frequencies. However, the FM efficiencies observed at high modulation frequencies of 50 and 75 MHz are considerably larger than this value. The underlying reason is likely related to the speed of EO modulation which becomes comparable to the photon lifetime in the resonator and the cavity resonance cannot adiabatically follow the EO modulation anymore.

The broadband EO response of the device would offer enormous bandwidth for locking of the soliton repetition rate to an external microwave reference. FIG. 13 illustrates locking of the soliton repetition rate to a reference microwave source. The schematic shown of the experimental testing setup includes an EDFA (erbium-doped fiber amplifier), FBG (fiber Bragg grating filter) and an amp (electrical amplifier). The soliton repletion rate is locked to an extern reference microwave source via two separate approaches. In the first “direct lock” approach, the external microwave directly drives the comb resonator. In the second approach, termed “RF feedback locking,” the detected microwave is compared with the external reference microwave and the error signal is used to feedback lock the comb resonator.

The driving electrodes are designed to support modulation speed significantly beyond the photon lifetime limit of the resonator. This is shown in FIGS. 14A and 14B, where the resonantly enhanced EO response is clearly evident at the modulation frequencies of 19.81 and 39.62 GHz that are equal to one and twice of the free-spectral range, and a comb-like sidebands can be produced by driving the comb resonator at a frequency of 19.81 GHz. The device offers an EO bandwidth up to tens of gigahertz for locking the soliton repetition rate, orders of magnitude larger than other approaches such as piezoelectric actuation. With this broadband modulation response of the comb resonator, the soliton repetition rate is locked in two ways. On one hand, the 19.81 GHz reference microwave is applied directly “direct lock” to the comb resonator during the soliton generation FIG. 13. The produced EO comb could seed the soliton generation and potentially stabilize its repetition rate. This approach is similar to the injection locking approach but the reference microwave is now fed directly to the comb resonator itself rather than through external modulation on the pump laser. As shown in the yellow curve in FIG. 14B, such a direct locking approach is able to suppress the phase noise by about 40 dB over the frequency range of 1 Hz-1 kHz. In the alternative, the feedback loop approach may be employed by comparing the detected microwave with the reference one and apply the error signal to feedback lock the pump-laser-cavity detuning. Here, such a feedback locking can be applied directly to the comb resonator, rather than externally tuning the frequency of the pump laser. As shown in the red curve of FIG. 14B, such a feedback locking approach is able to suppress nearly entirely the phase noise down to that of the reference microwave over the frequency range 1 Hz-3 kHz. The residual peaks around 10 kHz is primarily due to the bandwidth limit of the servo unit.

The phase-noise performance of the microwave can be improved further, given the enormous bandwidth (up to tens of gigahertz, see FIGS. 14A and 14B offered by the device for feedback locking. The current comb resonator chip is unpackaged, in which the LN chip and the lensed fiber used to couple the pump laser onto the chip (FIG. 13) are placed on separate stages whose mechanical vibrations would transfer into the fluctuations of the pump power launched into the comb resonator. This perturbation is dominantly responsible for the phase noise of the microwave at low frequencies when the device is free running and when the direct RF locking is implemented (FIG. 14B, blue and yellow curves). To mitigate its impact on the feedback locking, a proportional integral servo controller is implemented which, however, limited the operation bandwidth of feedback locking. With appropriate packaging of the chip [21, 23], the servo unit can be removed and the full bandwidth of the device can be employed for feedback locking, which is expected to significantly improve the phase-noise performance over a broad bandwidth. On the other hand, soliton microcombs exhibit a certain “quiet point” around which the phase noise of the microwave can be significantly suppressed due to the recoil effect between soliton SFS and dispersive wave produced via mode crossing. This approach may be implemented in the current design to further improve the phase-noise performance of the LN soliton microcombs.

In illustrative embodiments, the device is directed to a microwave-rate soliton microcomb whose repetition rate can be tuned at a high speed. By taking advantage of the strong electro-optic Pockels effect of LN and by integrating electro-optic tuning and modulation component directly into the LN comb resonator, a frequency modulation speed up to 75 MHz is achieved that is orders of magnitude faster than other soliton comb devices reported to date, and a frequency modulation rate up to 1.0×1015 Hz/s that is even faster than the state-of-the-art electronic microwave FM technology. The device exhibits a modulation efficiency of ˜2 MHz/V, which can be further increased by six times with all the three groups of driving electrodes employed. The demonstrated device offers a significant bandwidth (up to tens of giga-hertz) for feedback locking of the repetition rate to an external reference source, enabling both direct injection locking and feedback locking to the comb resonator itself without involving external modulation. With this approach, the low-frequency phase noise is suppressed directly down to that of the reference source. The demonstrated device and approach unite elegantly the superior coherence of soliton microcombs with high-speed dynamic modulation, opening up a great avenue towards electro-optic processing of coherent microwaves that is expected to find broad applications in microwave synthesis, time keeping, ranging, 5G/6G communications, among many others. Moreover, beyond microwave processing, the direct EO tuning and modulation of the soli-ton comb lines is expected to have a profound impact on the general photonic applications of soliton microcombs including frequency metrology, optical frequency synthesis, LiDAR, and optical communication.

In illustrative embodiments, the device may be fabricated on a 610-nm z-cut LN-on-insulator (LNOI) wafer. Ring resonators and waveguides structures were defined by the first electron beam lithography with ZEP520a as resist, which were etched down by about 410 nm with the help of Ar ion milling. After removing ZEP520a residue, the 525 nm Au electrodes were patterned by the second exposure with PMMA as resist, and deposited by the electron beam evaporator. An overnight lift-off process were applied to remove PMMA and useless Au.

### Design of the Pulley Coupling Waveguide

In other illustrative embodiments, a pulley coupling waveguide is provided whereby the resonator is close to critical coupling around the pump wavelength of 1550 nm but it is strongly over-coupled at the Raman Stokes wavelength around 1720 nm. The effective refractive index of the waveguides is modeled by the finite-element method via COMSOL, and the coupling condition of the bus waveguide can be simulated with a coupled-mode theory. Our detailed modeling show that the desired coupling condition can be obtained with a bus-waveguide width of 1.765 μm, a pulley angle of 10 degrees, and a constant gap of 300 nm between the bus waveguide and the ring resonator in the pulley coupling region. FIG. 5 shows the simulated ratio of the external coupling Q, Qex, to the intrinsic optical Q, Q0. It shows that such a pulley waveguide design is able to achieve nearly critical coupling at the pump wavelength of 1550 nm but is strongly over coupled at the Raman Stokes wavelength around 1720 nm. A side effect of such a design is that a coupling resonance appears around a wavelength of 1580 nm around which the resonator is deeply under coupled. This side effect is responsible for the spectral distortion of the soliton combs shown in FIGS. 7A and 7C. The side effect can be removed by further optimizing the pulley waveguide design.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A microwave-rate soliton microcomb for high-speed tuning soliton microcomb comprising an on-chip high-Q lithium niobate (LN) microresonator as a comb resonator whose dispersion is engineered for soliton comb generation where a strong electro-optic Pockels effect is used to dynamically tune the soliton repetition rate, by directly integrating electrooptic tuning and modulation elements into the comb resonator.

2. The microwave-rate soliton microcomb of claim 1, whose repetition rate can be tuned at a high speed.

3. The microwave-rate soliton microcomb of claim 1, wherein, by taking advantage of the strong electro-optic Pockels effect of LN and by integrating electro-optic tuning and modulation component directly into the LN comb resonator, a frequency modulation speed up to 75 MHz is achieved and a frequency modulation rate up to 1.0×1015 Hz/s.

4. The microwave-rate soliton microcomb of claim 1, wherein, the device exhibits a modulation efficiency of ˜2 MHz/V.

5. The microwave-rate soliton microcomb of claim 1, wherein, the demonstrated device offers a significant bandwidth (up to tens of gigahertz) for feedback locking of the repetition rate to an external reference source, enabling both direct injection locking and feedback locking to the comb resonator itself without involving external modulation.

6. The microwave-rate soliton microcomb of claim 1, wherein, the low-frequency phase noise is suppressed directly down to that of the reference source.

7. The microwave-rate soliton microcomb of claim 1, wherein, the demonstrated device and approach include soliton microcombs with high-speed dynamic modulation.
